(19) United States
(12) Patent Application Publication
(10) Pub. No.: US 2024/0209983 A1
(43) Pub. Date: Jun. 27, 2024

(54) HANDHELD GIMBAL, HANDHELD GIMBAL CONTROL METHOD AND APPARATUS, AND STORAGE MEDIUM

(71) Applicant: SZ DJI TECHNOLOGY CO., LTD., Shenzhen (CN)

(72) Inventors: Jinxian LV, Shenzhen (CN); Yi HAO, Shenzhen (CN); Long LI, Shenzhen (CN); Hui LIU, Shenzhen (CN)

(21) Appl. No.: 18/600,615

(22) Filed: Mar. 8, 2024

Related U.S. Application Data
(63) Continuation of application No. PCT/CN2021/117494, filed on Sep. 9, 2021.

(51) Int. Cl. F16M 13/04; F16M 11/12; F16M 11/18; G03B 17/56; H04M 1/04

(52) U.S. Cl. CPC F16M 13/04; F16M 11/123; F16M 11/18; G03B 17/561; H04M 1/04

(57) ABSTRACT

An apparatus includes a body, a detection member, one or more processors, and one or more memories. The body is configured to carry a payload and is in one of a plurality of different states. The plurality of different states include a folded state and an unfolded state. The first detection member is mounted at the body and includes a magnetic sensor. The one or more memories store one or more computer programs that, when executed by the one or more processors, cause the one or more processors to obtain detection information collected by the first detection member and control the apparatus to be in a standby mode or an operation mode according to the first detection information. The detection information is related to the folded state or the unfolded state of the body.

### CROSS-REFERENCE TO RELATED APPLICATION

This application is a continuation of International Application No. PCT/CN2021/117494, filed Sep. 9, 2021, the entire content of which is incorporated herein by reference.

### TECHNICAL FIELD

The present disclosure relates to the handheld gimbal field and, more particularly, to a handheld gimbal, a control method for the handheld gimbal, a control apparatus, and a storage medium.

### BACKGROUND

Handheld gimbal is compact and portable, allowing for the installation thereon of small shooting devices such as cameras, camcorders, smartphones, etc. It provides quick and stable control of the shooting device to maintain a determined posture while in motion. During the user's stabilizing shooting process with the handheld gimbal, if there is a need to separately use the attached payload, in order to avoid potential damage to the gimbal's motors caused by the independent use of the payload, it is necessary to manually turn off the handheld gimbal. After the user has finished using the payload, it requires cumbersome operations to restore the normal functioning of the handheld gimbal, resulting in a poor user experience.

### SUMMARY

In accordance with the disclosure, there is provided an apparatus including a body, a detection member, one or more processors, and one or more memories. The body is configured to carry a payload and is in one of a plurality of different states. The plurality of different states include a folded state and an unfolded state. The first detection member is mounted at the body and includes a magnetic sensor. The one or more memories store one or more computer programs that, when executed by the one or more processors, cause the one or more processors to obtain detection information collected by the first detection member and control the apparatus to be in a standby mode or an operation mode according to the first detection information. The detection information is related to the folded state or the unfolded state of the body.

Also in accordance with the disclosure, there is provided a control method. The method includes obtaining detection information collected by a detection member arranged at a body of an apparatus and controlling the apparatus to be in a standby mode or an operation mode according to the first detection information. The body is configured to be in one of a plurality of different states. The plurality of different states include a folded state and an unfolded state. The detection member is arranged at the body and includes a magnetic sensor. The detection information is related to the folded state or the unfolded state of the body.

Also in accordance with the disclosure, there is provided a control method. The method includes obtaining first detection information of a body of an apparatus collected by a first detection member and second detection information collected by a second detection member of a payload c and controlling the apparatus to be in a standby mode or an operation mode according to the first detection information and the second detection information. The body is configured to carry the payload and be in one of a plurality of different states. The plurality of different states include a folded state and an unfolded state. The first detection member and the second detection member are arranged at the body. The first detection information is related to the folded state or the unfolded state of the body. The second detection information is related to a connection state of the body and the payload.

### BRIEF DESCRIPTION OF THE DRAWINGS

FIG. 1 is a schematic perspective structural diagram of a handheld gimbal consistent with an embodiment of the present disclosure.

FIG. 2 is a schematic perspective structural diagram of another handheld gimbal consistent with an embodiment of the present disclosure.

FIG. 3 is a schematic perspective structural diagram of another handheld gimbal consistent with an embodiment of the present disclosure.

FIG. 4 is a schematic flowchart of a control method for a handheld gimbal consistent with an embodiment of the present disclosure.

FIG. 5 is a schematic structural block diagram of a control apparatus of a handheld gimbal consistent with an embodiment of the present disclosure.

### DETAILED DESCRIPTION OF THE EMBODIMENTS

The technical solution of embodiments of the present disclosure is described in detail in connection with the accompanying drawings. Described embodiments are some embodiments of the present disclosure, not all embodiments. Based on embodiments of the present disclosure, all other embodiments obtained by those of ordinary skill in the art without creative efforts are within the scope of the present disclosure.

Embodiments of the present disclosure are described in detail below. Embodiments of the present disclosure are shown in the accompanying drawings. Same or similar signs represent the same or similar elements or elements with the same or similar functions. The description of embodiments with reference to the accompanying drawings is exemplary, which is merely used to explain the present disclosure and cannot be understood as a limitation of the present disclosure.

The terms “first” and “second” are only used for descriptive purposes and cannot be understood as indicating or implying relative importance or implicitly indicating the number of indicated technical features. Thus, a feature as associated with “first” and “second” may explicitly or implicitly include one or more of the features. In the description of the present disclosure, “a plurality of” means two or more than two, unless otherwise specifically defined.

In the description of embodiments of the present disclosure, the terms “mount,” “connection,” and “coupling” should be understood in a broad sense. For example, the terms may indicate a fixed connection, a detachable connection, an integral connection, a mechanical connection, an electrical connection, a communication, a direct connection, an indirect connection through an intermediary, internal communication of two components, or interaction relationship of two components. Those of ordinary skill in the art should understand the specific meanings of the above terms in embodiments of the present disclosure according to specific situations.

In connection with the accompanying drawings, some embodiments of the present disclosure are described in detail. When there is no conflict, embodiments and features of embodiments can be combined with each other. The flowchart in the accompanying drawings is merely illustrative and does not necessarily include all contents and operations/steps, and the operations/steps do not need to be performed according to the order described in the accompanying drawings. For example, some operations/steps can be divided, grouped, or partially combined. Thus, the actual sequence for performing the operations/steps can be different according to actual situations.

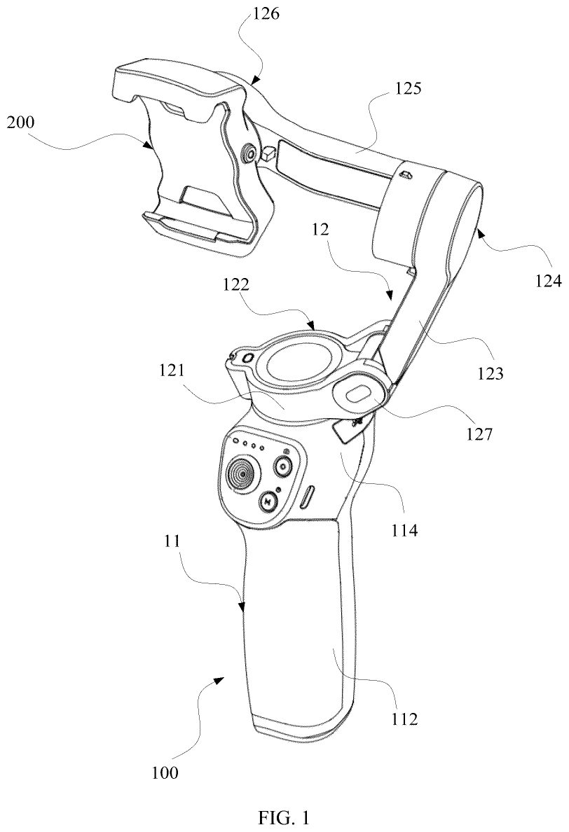

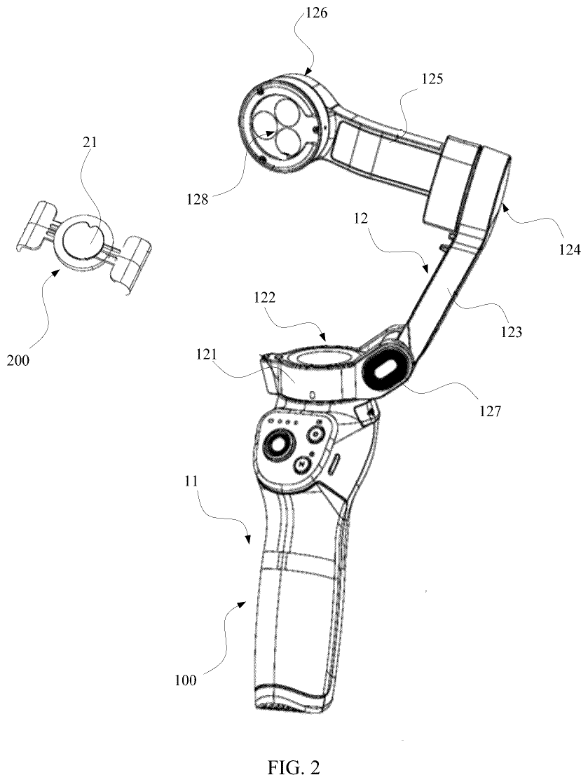

As shown in FIG. 1 and FIG. 2, a handheld gimbal 100 of embodiments of the present disclosure includes a handheld member 11, a gimbal member 12, and a controller (not shown in FIG. 1 and FIG. 2). The gimbal member 12 is arranged at the handheld member 11 and configured to be detachably connected to a payload and adjust an attitude of the payload. The controller can be arranged inside the handheld member 11. The gimbal member 12 can include a first detection member (not shown in FIG. 1 and FIG. 2) and a second detection member (not shown in FIG. 1 and FIG. 2). The first detection member can be configured to collect folding detection information of the gimbal member 12. The second detection member can be configured to collect payload detection information of the gimbal member 12. The payload can include a cell phone, a camera, or a tablet computer.

In some embodiments, the handheld gimbal 100 can be configured for stabilization. In the examples shown in FIG. 1 and FIG. 2, the handheld member 11 is a rod-shaped structure and includes a top member 112 and a bottom member 114. The handheld member 11 includes an input element. The input element can include a control button, a joystick, a dial wheel, etc. The input element can be configured to input a control instruction to adjust the attitude and/or shooting parameters of the payload. In other embodiments, the input element can be omitted from the handheld member 11, and the control instruction can be sent to the handheld gimbal by a mobile terminal that communicates with the handheld gimbal.

In some embodiments, the controller can be configured to obtain the folding detection information collected by the first detection member and the payload detection information collected by the second detection member. According to the folding detection information, whether the gimbal member 12 is in a folded state can be determined, and according to the payload detection information, whether the gimbal member 12 carries a payload can be determined. When the gimbal member 12 is determined to be without the payload and in a folded state, the gimbal member 12 can be controlled to be in a standby mode. When the gimbal member 12 is determined to carry a payload and be in an unfolded state, the gimbal member 12 can be controlled to be in an operation mode.

The controller can control the gimbal member 12 to be in the standby mode when the gimbal member 12 does not carry the payload and is in the folded state. Then, the user can conveniently use the payload independently. When the gimbal member 12 carries the payload and is in an unfolded state, the controller can control the gimbal member 12 to be in the operation mode to restore the normal operation of the handheld gimbal 100. Thus, the application convenience of the handheld gimbal 100 can be improved, which facilitates the user operation and improves the user experience.

The gimbal member 12 includes a first connection arm 121 (e.g., an integral structure integrated with the housing of a yaw motor 122), the yaw motor 122, a second connection arm 123, a pitch motor 124, a third connection arm 125, the roll motor 126, and a rotation connector 127. The rotation connector 127 is arranged between the first connection arm 121 and the second connection arm 123. One end of the rotation connector 127 is rotatably connected to the first connection arm 121, and the other end of the rotation connector 127 is rotatably connected to the second connection arm 123. The gimbal member 12 can rotate around the rotation connector 127 to switch between the folded state and the unfolded state (the handheld gimbal 100 in FIG. 1 and FIG. 2 being in the unfolded state).

The yaw motor 122 can be connected to the top member 112 of the handheld member 11. One end of the first connection arm 121 can be rotatably connected to an end of the second connection arm 123 through the rotation connector 127. The other end of the first connection arm 121 can be fixedly connected to the rotor member of the yaw motor 122. The other end of the second connection arm 123 can be rotatably connected to the first connection arm 121 through the rotation connector 127. An end of the third connection arm 125 can be fixedly connected to the stator member of the roll motor 126. The other end of the third connection arm 125 can be fixedly connected to the rotor member of the pitch motor 124. In some other embodiments, the gimbal member can also be a single-shaft or duo-shaft gimbal member. In some other embodiments, the yaw motor 122, the pitch motor 124, and the roll motor 126 can be connected in sequences other than the sequence above.

In some embodiments, the first detection member can include a first magnetic member and a first magnetic sensor. The first magnetic member can be arranged at the first connection arm 121, and the first magnetic sensor can be arranged at the second connection arm 123. In some other embodiments, the first magnetic member can be arranged at the second connection arm 123, and the first magnetic sensor can be arranged at the first connection arm 121. The first magnetic sensor can be configured to collect the first magnetic field strength. The first magnetic member can be a single magnetic member or a dual magnetic member.

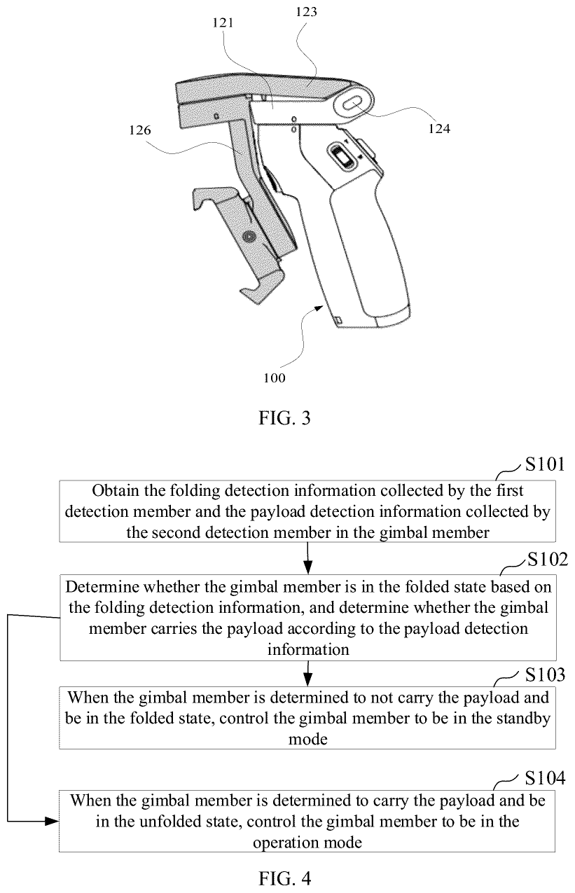

When the gimbal member 12 is in the unfolded state, the first connection arm 121 does not contact the second connection arm 123, and the first magnetic sensor cannot sense the magnetic field of the first magnetic member. As shown in FIG. 3, when the gimbal member 12 is in the folded state, the first connection arm 121 contacts the second connection arm 123, and the first magnetic sensor can sense the magnetic field of the first magnetic member. Therefore, with the first magnetic field strength collected by the first magnetic sensor, the gimbal member 12 can be quickly and conveniently determined to be in the unfolded state or the folded state.

In some embodiments, the first detection member can include an angle sensor. The angle sensor can be arranged at the rotation connector 127 and configured to collect the angle between the first connection arm 121 and the second connection arm 123. The first connection arm 121 can have an angle with the second connection arm 123. As shown in FIG. 1 and FIG. 2, the angle between the first connection arm 121 and the second connection arm 123 when the gimbal member 12 is in the unfolded state is greater than the angle between the first connection arm 121 and the second connection arm 123 when the gimbal member 12 is in the folded state. Therefore, with the angle between the first connection arm 121 and the second connection arm 123, whether the gimbal member 12 is in the unfolded state or the folded state can be quickly and conveniently determined.

In some embodiments, the folding detection information can include at least one of the first magnetic field strength collected by the first magnetic sensor and the angle between the first connection arm 121 and the second connection arm 123. The controller can be further configured to determine that the gimbal member 12 is in the folded state when the first magnetic field strength is greater than or equal to a predetermined first magnetic field strength threshold and/or the angle between the first connection arm 121 and the second connection arm 123 is less than or equal to a predetermined angle threshold, and determine that the gimbal member 12 is in the unfolded state when the first magnetic field strength is less than the predetermined first magnetic field strength threshold and/or the angle between the first connection arm 121 and the second connection arm 123 is greater than the predetermined angle threshold. The first magnetic field strength threshold and the predetermined angle threshold can be set as needed, which is not limited here.

As shown in FIG. 1, the roll motor 126 of the gimbal member 12 is configured to drive the payload connector 200 connecting the payload to rotate. The payload connector 200 is integrated with the gimbal member 12. The second detection member is arranged at the payload connector 200. The payload connector 200 can be configured to connect the payload. The second detection member can include a second magnetic sensor and/or a pressure sensor. The second magnetic sensor can be configured to collect the second magnetic field strength, and the pressure sensor can be configured to collect a pressure value borne by the payload connector.

When the payload connector 200 carries a payload, the pressure value collected by the pressure sensor can be greater than the pressure value collected by the pressure sensor when the payload connector 200 does not carry the payload. Moreover, the pressure value collected by the pressure sensor when the payload connector 200 carries the payload can be related to the weight of the payload. Therefore, with the pressure value collected by the pressure sensor, whether the payload connector 200 carries the payload can be quickly and conveniently determined. In some embodiments, a second magnetic member can be arranged at the back side of the payload. The second magnetic member can be a single magnetic member or dual magnetic member. When the payload connector 200 carries the payload, the second magnetic sensor can sense the magnetic field of the second magnetic member. When the payload connector 200 does not carry the payload, the second magnetic sensor cannot sense the magnetic field of the second magnetic member. Thus, with the second magnetic field strength collected by the second magnetic sensor, whether the payload connector 200 carries the payload can be quickly and conveniently determined.

In some embodiments, the payload detection information can include at least one of the second magnetic field strength collected by the second magnetic sensor and the pressure value collected by the pressure sensor. The controller can be further configured to determine that the gimbal member 12 carries the payload when the second magnetic field strength is greater than or equal to a predetermined second magnetic field strength threshold and/or the pressure value is greater than or equal to the predetermined pressure threshold, and determine that the gimbal member 12 does not carry the payload when the second magnetic field strength is less than the second magnetic field strength threshold and/or when the pressure value is less than the predetermined pressure threshold. The second magnetic field strength threshold and the predetermined pressure threshold can be arranged as needed and are not limited here.

As shown in FIG. 2, the gimbal member 12 also includes a first attraction member 128 including the second detection member. The first attraction member 128 can be fixedly connected to the roll motor 126 of the gimbal member 12. The first attraction member 128 can be magnetically attracted to a second attraction member 21 at the payload connector 200. Thus, when the payload connector 200 is installed, the payload connector 200 can be detachably mounted at the roll motor 126. Then, the roll motor 126 can drive the payload connector 200 to rotate.

In some embodiments, the roll motor 126 can include a stator member and a rotor member that is rotatable relative to the stator member. The first attraction member 128 can be fixedly connected to the stator member or the rotor member of the roll motor 126. The first attraction member 128 can be magnetically attracted to the second attraction member 21. Thus, when the payload connector 200 is installed, the rotor member can rotate relative to the stator member until the first attraction member 128 and the second attraction member 21 face each other and are attached together. Then, the payload connector 200 can be detachably mounted at the rotor member or the stator member, and the roll motor 126 can drive the payload connector 200 to rotate. The magnetic attraction connection method utilizes the mutual attraction between magnets and magnetic materials that can be attracted by magnets, or the attraction between two magnets with opposite polarities. The magnetic member has two poles, an N pole, and an S pole, and the magnetic material is a soft magnetic material.

The first attraction member 128 can include a single-sided single-pole magnetic member, a single-sided dual-pole magnetic member, or another magnetizable member. The other magnetizable member can be attracted by the magnetic member. For example, the other magnetizable member can include iron, nickel, and cobalt. In some embodiments, the single-sided single-pole magnetic member can include two end surfaces facing away from each other. Each end surface can include a unique magnetic pole. One end surface can have N pole, and the other end surface can have S pole. The magnetic induction curve of the single-sided single-pole magnetic member passes from the N pole to the S pole. The magnetic path of the single-sided single-pole magnetic member can be relatively open and have a wide range of attracting other attraction members. The shape of the single-sided single-pole magnetic member can include, but is not limited to, a circular shape, an elliptical shape, and a rectangular shape.

In the handheld gimbal 100 shown in FIG. 2, the pressure value collected by the pressure sensor when the payload connector 200 carries the payload is greater than the pressure value collected by the pressure sensor when the payload connector 200 does not carry the payload, and the pressure value collected by the pressure sensor when the payload connector 200 carries the payload can be related to the weight of the payload. Thus, with the pressure value collected by the pressure sensor, whether the payload connector 200 carries the payload can be quickly and conveniently determined.

In some embodiments, the second attraction member 21 can include a single-sided single-pole magnetic member and a single-sided dual-pole magnetic member. The number of single-sided single-pole magnetic member and the number of single-sided dual-pole magnetic member in the second attraction member 21 can be the same as the number of single-sided single-pole magnetic member and the number of single-sided dual-pole magnetic member in the first attraction member 128, respectively. The polarities of the corresponding magnetic member of the second attraction member 21 can be opposite to the polarities of the magnetic member of the first attraction member 128. When the payload connector 200 approaches the gimbal member from a distance of 30 mm or more, the payload connector 200 can first be attracted by the single-sided single-pole magnetic member to guide the roll motor 126 and the payload connector 200 to automatically correct the positions to cause the relative angle between the roll motor 126 and the payload connector 200 to be in a certain ranged. When the roll motor 126 and the payload connector 200 continue to approach each other, and the distance is around 5 mm, the attraction force of the single-sided dual-pole magnetic member can gradually increase to further correct the positions of the roll motor 126 and the payload connector 200. When the roll motor 126 is close to the payload connector 200, the roll motor 126 and the payload connector 200 can be accurately positioned, which prevents the payload connector 200 from tilting to a side.

In some embodiments, in the standby mode, the motors of the gimbal member 12 can be in a powered-off state and/or a locked state. For example, the roll motor 126, the pitch motor 124, and the yaw motor 122 can be in the powered-off state and/or the locked state. In the operation mode, the motors of the gimbal member 12 can be in a powered-on state and an unlocked state. For example, the roll motor 126, the pitch motor 124, and the yaw motor 122 can be in the powered-on state and the unlocked state. A motor in the locked state cannot rotate freely, and a motor in the unlocked state can rotate freely within the position limits of the motor.

FIG. 4 is a schematic flowchart of a control method for a handheld gimbal consistent with an embodiment of the present disclosure.

As shown in FIG. 4, the control method for the handheld gimbal includes processes S101 to S104.

At S101, the folding detection information collected by the first detection member and the payload detection information collected by the second detection member of the gimbal member are obtained.

For example, the first detection member can include the first magnetic sensor and/or the angle sensor. The folding detection information can include the first magnetic field strength collected by the first magnetic sensor and/or the angle between the first connection arm and the second connection arm of the gimbal member collected by the angle sensor. For example, the second detection member can include the second magnetic sensor and/or pressure sensor. The payload detection information can include the second magnetic field strength collected by the second magnetic sensor and/or the pressure value collected by the pressure sensor.

At S102, whether the gimbal member is in the folded state is determined based on the folding detection information, and whether the gimbal member carries the payload is determined according to the payload detection information.

For example, when the first magnetic field strength is greater than or equal to the predetermined first magnetic field strength threshold and/or the angle is less than or equal to the predetermined angle threshold, the gimbal member can be determined to be in the folded state. When the first magnetic field strength is less than the first magnetic field strength threshold and/or the angle is greater than the predetermined angle threshold, the gimbal member can be determined to be in the unfolded state. The first magnetic field strength threshold and the predetermined angle threshold can be set as needed and are not limited here.

For example, when the second magnetic field strength is greater than or equal to the predetermined second magnetic field strength threshold and/or the pressure value is greater than or equal to the predetermined pressure threshold, the gimbal member can be determined to carry the payload. When the second magnetic field strength is less than the second magnetic field strength threshold and/or the pressure value is less than the predetermined pressure threshold, the gimbal member can be determined to not carry the payload. The second magnetic field strength threshold and the predetermined pressure threshold can be set as needed and not be limited here.

At S103, when the gimbal member is determined to not carry the payload and be in the folded state, the gimbal member is controlled to be in the standby mode.

In the standby mode, the motors of the gimbal member can be in the powered-off state and/or the locked state. For example, the roll motor, the pitch motor, and the yaw motor of the gimbal member can be in the powered-off state and/or the locked state. The motor in the locked state cannot rotate freely. Controlling the gimbal member to be in the standby mode can include controlling the motors of the gimbal member to be in the powered-off state and/or the locked state.

At S104, when the gimbal member is determined to carry the payload and be in the unfolded state, the gimbal member is controlled to be in the operation mode.

In the operation mode, the motors of the gimbal member can be in the powered-on state and the unlocked state. For example, the roll motor, the pitch motor, and the yaw motor of the gimbal member can be in the powered-on state and the unlocked state. The motor in the unlocked state can rotate freely within the position limits of the motor. Controlling the gimbal member to be in the operation mode can include controlling the motors of the gimbal member to be in the powered-on state and the unlocked state.

In the control method for the handheld gimbal of embodiments of the present disclosure, when the gimbal member does not carry the payload and is in the folded state, controlling the gimbal member to be in the standby mode can facilitate the user to use the payload independently. When the gimbal member carries the payload and is in the unfolded state, the gimbal member can be controlled to be in the operation mode to restore the normal operation of the handheld gimbal, which greatly improves the application convenience of the handheld gimbal, facilitates the user to operate, and improves the user experience.

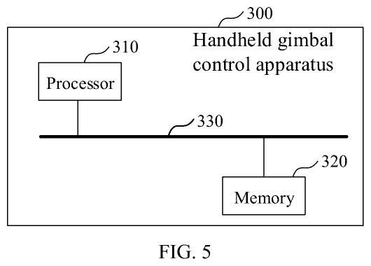

FIG. 5 is a schematic structural block diagram of a control apparatus of a handheld gimbal consistent with an embodiment of the present disclosure. The handheld gimbal includes a handheld member and a gimbal member arranged at the handheld member. The gimbal member can be configured to carry the payload and adjust the attitude of the payload.

As shown in FIG. 5, a control device 300 for the handheld gimbal includes a processor 310 and a memory 320. The processor 310 and the memory 320 are connected via a bus 330. The bus 330 can include, for example, an Inter-integrated Circuit (I2C) bus.

In some embodiments, the processor 310 can include a microcontroller unit (MCU), a central processing unit (CPU), or a digital signal processor (DSP), etc.

In some embodiments, the memory 320 can include a Flash chip, a read-only memory (ROM) disk, an optical disk, a USB drive, or an external hard drive.

The processor 310 can be configured to execute a computer program stored in the memory 320 to obtain the folding detection information collected by the first detection member of the gimbal member and the payload detection information collected by the second detection member, determine whether the gimbal member is in the folded state according to the folding detection information and determine whether the gimbal member carries the payload according to the payload detection information, control the gimbal member to be in the standby mode when determining that the gimbal member does not carry the payload and is in the folded state, and control the gimbal member to be in the operation mode when determining that the gimbal ember carries the payload and is in the unfolded state.

In some embodiments, the first detection member can include the first magnetic sensor and/or the angle sensor. The folding detection information can include the first magnetic field strength collected by the first magnetic sensor and/or the angle between the first connection arm and the second connection arm of the gimbal member collected by the angle sensor. When determining whether the gimbal member is in the folded state according to the folding detection information, the processor can be configured to, when the first magnetic field strength is greater than or equal to the predetermined first magnetic field strength threshold and/or the angle is less than or equal to the predetermined angle threshold, determine that the gimbal member is in the folded state, and when the first magnetic field strength is smaller than the first magnetic field strength threshold and/or the angle is greater than the predetermined angle threshold, determine that the gimbal member is in the unfolded state.

In some embodiments, the second detection member can include the second magnetic sensor and/or the pressure sensor. The payload detection information can include the second magnetic field strength collected by the second magnetic sensor and/or the pressure value collected by the pressure sensor.

When determining whether the gimbal member carries the payload according to the payload detection information, the processor can be configured to determine that the gimbal member carries the payload when the second magnetic field strength is greater than or equal to the predetermined second magnetic field strength threshold and/or the pressure value is greater than or equal to the predetermined pressure threshold, and determine that the gimbal member does not carry the payload when the second magnetic field strength is smaller than the second magnetic field strength threshold and/or the pressure value is smaller than the predetermined pressure threshold.

Those skilled in the art can understand that, for the convenience and brevity of the description, for the specific operation process of the control device of the handheld gimbal, reference can be made to the corresponding process of the control method for the handheld gimbal, which is not repeated here.

Embodiments of the present disclosure further provide a computer-readable storage medium. The computer-readable storage medium stores a computer program. The computer program can include a program instruction. The processor executes the program instruction to perform the steps of the control method for the handheld gimbal of embodiments of the present disclosure.

The computer-readable storage medium can be an internal storage unit of the handheld gimbal or the control device of any of the above embodiments, such as the hard drive or memory of the handheld gimbal or control device. The computer-readable storage medium can also be an external storage device of the handheld gimbal or control device, such as a plug-in hard drive on a control terminal or an unmanned aircraft, a smart media card (SMC), a secure digital (SD) card, a flash card, etc.

The terms used in the present disclosure are for the purpose of describing specific embodiments and are not intended to limit the scope of the present disclosure. As used in the present disclosure and the appended claims, unless the context clearly indicates otherwise, the singular forms “a,” “an,” and “the” are intended to include the plural form.

Furthermore, the term “and/or” used in the present disclosure and the appended claims refers to any one or more of the items listed in the related list and any combination of all possible combinations, including all of those combinations.

The above description is only specific embodiments of the present disclosure, but the scope of the present disclosure is not limited to this. Those skilled in the art can easily think of various equivalent modifications or substitutions within the scope of the present disclosure. These modifications or substitutions are within the scope of the present disclosure. Therefore, the scope of the present disclosure should be subject to the scope of the claims.

What is claimed is:

1. An apparatus comprising:
a body configured to carry a load and be in one of a plurality of different states including a folded state and an unfolded state;
a detection member mounted at the body and including a magnetic sensor;
one or more processors; and
one or more memories storing one or more computer programs that, when executed by the one or more processors, cause the one or more processors to:
obtain detection information collected by the detection member, the detection information being related to the folded state or the unfolded state of the body; and
control the apparatus to be in a standby mode or an operation mode according to the detection information.

2. The apparatus according to claim 1, wherein:
the body includes a first member, a second member, and a rotation connector arranged between the first member and the second member and is configured to be folded and unfolded through the rotation connector; and
one end of the rotation connector is rotatably connected to the first member, and another end of the rotation connector is rotatably connected to the second member.

3. The apparatus according to claim 2, wherein:
at least one of the first member or the second member includes a connection arm of the body; and
the magnetic sensor is arranged at the connection arm.

4. The apparatus according to claim 2, wherein:
the detection member further includes a magnetic member arranged at one of the first member and the second member; and
the magnetic sensor is arranged at another one of the first member and the second member, and is configured to detect a magnetic field strength.

5. The apparatus according to claim 2, wherein the detection member further includes:
an angle sensor arranged at the rotation connector and configured to detect an angle between the first member and the second member.

6. The apparatus according to claim 2, wherein:
the body further includes a yaw motor, a pitch motor, and a roll motor; and
the rotation connector is arranged between the yaw motor and the pitch motor, between the pitch motor and the roll motor, or between the yaw motor and the roll motor.

7. The apparatus according to claim 6, wherein:
the first member includes a first connection arm of the body, the second member includes a second connection arm of the body, and the body further includes a third connection arm;
one end of the first connection arm is connected to the yaw motor, and another end of the first connection arm is connected to the rotation connector;
one end of the second connection arm is connected to the pitch motor, and another end of the second connection arm is connected to the rotation connector; and
one end of the third connection arm is connected to the roll motor, and another end of the third connection arm is connected to the yaw motor.

8. The apparatus according to claim 2, wherein:
the detection information includes at least one of a magnetic field strength detected by the magnetic sensor or an angle between the first member and the second member; and
the one or more computer programs, when executed by the one or more processors, further cause the one or more processors to:
in response to the magnetic field strength being greater than or equal to a magnetic field strength threshold and/or the angle being smaller than or equal to an angle threshold, determine that the body is in the folded state; and
in response the magnetic field strength being smaller than the magnetic field strength threshold and/or the angle being greater than the angle threshold, determine that the body is in the unfolded state.

9. The apparatus according to claim 1, wherein controlling the apparatus to be in the standby mode or the operation mode according to the detection information includes:
in response to the detection information indicating that the body is in the folded state, controlling the apparatus to be in the standby mode; and/or
in response to the first detection information indicating that the body is in the unfolded state, controlling the apparatus to be in the operation mode.

10. The apparatus according to claim 1, wherein:
the detection member is a first detection member and the detection information is first detection information; and
the body further includes:
a payload connector configured to connect the payload; and
a second detection member arranged at the payload connector and configured to collect second detection information of the body, the second detection information being related to a connection state between the body and the payload.

11. The apparatus according to claim 10, wherein the body further includes:
a roll motor configured to drive the payload connector connecting the payload to rotate.

12. The apparatus according to claim 10, wherein:
the body further includes a first attraction member provided with the second detection member, the first attraction member being fixedly connected to a roll motor of the body; and
the first attraction member is configured to be attracted to a second attraction member of the payload connector through a magnetic force to detachably mount the payload connector at the roll motor to allow the roll motor to drive the payload connector to rotate.

13. The apparatus according to claim 10, wherein
the magnetic sensor is a first magnetic sensor; and
the second detection member includes at least one of:
a second magnetic sensor configured to detect a magnetic field strength; or
a pressure sensor configured to collect a pressure value borne by the payload connector.

14. The apparatus according to claim 13, wherein:
the second detection information includes at least one of the magnetic field strength detected by the second magnetic sensor or the pressure value collected by the pressure sensor; and
the one or more computer programs, when executed by the one or more processors, further cause the one or more processors to:
in response to the second magnetic field strength being greater than or equal to a magnetic field strength threshold and/or the pressure value being greater than or equal to a pressure threshold, determine that the body carries the payload; and
in response to the second magnetic field strength being smaller than the magnetic field strength threshold and/or the pressure value being smaller than the pressure threshold, determine that the body carries no payload.

15. The apparatus according to claim 10, wherein the one or more computer programs, when executed by the one or more processors, further cause the one or more processors to:
in response to the second detection information indicating that the payload connector is connected to the payload, control the apparatus to be in the operation mode; and/or
in response to the second detection information indicating that the payload connector is not connected to the payload, control the apparatus to be in the standby mode.

16. The apparatus according to claim 10, wherein controlling the apparatus to be in the standby mode or the operation mode includes:
in response to the second detection information indicating that the payload connector is not connected to the payload, or the first detection information indicating that the body is in the folded state, control the apparatus to be in the standby mode; and/or
in response to the second detection information indicating that the payload connector is connected to the payload, and the first detection information indicating that the body is in the unfolded state, control the apparatus to be in the operation mode.

17. The apparatus according to claim 1, wherein:
the body further includes one or more motors;
in the standby mode, the one or more motors are in a powered-off state and/or a locked state; and
in the operation mode, the one or more motors are in a powered-on state and an unlocked state.

18. The apparatus according to claim 1, further comprising:
a handheld member connected to the body;
wherein:
the one or more processors are arranged at the handheld member; and
the body includes a gimbal member.

19. A control method comprising:
obtaining first detection information collected by a detection member arranged at a body of an apparatus, wherein:
the body is configured to be in one of a plurality of different states including a folded state and an unfolded state;
the detection member is arranged at the body and includes a magnetic sensor; and
the detection information is related to the folded state or the unfolded state of the body; and
controlling the apparatus to be in a standby mode or an operation mode according to the first detection information.

20. A control method comprising:
obtaining first detection information collected by a first detection member and second detection information collected by a second detection member, wherein:
the body is configured to carry the payload and be in one of a plurality of different states including a folded state and an unfolded state;
the first detection member and the second detection member are arranged at the body;
the first detection information is related to the folded state or the unfolded state of the body; and
the second detection information is related to a connection state between the body and the payload; and
controlling the apparatus to be in a standby mode or an operation mode according to the first detection information and the second detection information.
